(19) United States
(12) Patent Application Publication
(10) Pub. No.: US 2015/0056507 A1
(43) Pub. Date: Feb. 26, 2015

(54) LITHIUM-BASED BATTERY ELECTRODES

(71) Applicant: GM GLOBAL TECHNOLOGY OPERATIONS LLC, Detroit, MI (US)

(72) Inventors: Gayatri Vyas Dadheech, Bloomfield Hills, MI (US); Mei Cai, Bloomfield Hills, MI (US); Li Yang, Troy, MI (US)

(21) Appl. No.: 14/464,390

(22) Filed: Aug. 20, 2014

Related U.S. Application Data
(60) Provisional application No. 61/868,370, filed on Aug. 21, 2013.

(51) Int. Cl. H01M 4/36; H01M 4/13; H01M 10/052; H01M 4/38; H01M 4/62

(52) U.S. Cl. CPC H01M 4/366; H01M 4/38; H01M 4/625; H01M 4/62; H01M 10/052; H01M 4/13
USPC 429/218.1

(57) ABSTRACT

An example of a positive electrode includes sulfur based active material particles, a carbon coating encapsulating the sulfur based active material particles, and a structure coating formed on a surface of the carbon coating. The structure coating is selected from the group consisting of a metal oxide composite structure, a mixed carbon and metal oxide composite structure, and a polymeric structure coating.

### CROSS-REFERENCE TO RELATED APPLICATIONS

This application claims the benefit of U.S. Patent Provisional Application Ser. No. 61/868,370, filed Aug. 21, 2013, which is incorporated by reference herein in its entirety.

### BACKGROUND

Secondary, or rechargeable, lithium-sulfur batteries or lithium ion batteries are often used in many stationary and portable devices, such as those encountered in the consumer electronic, automobile, and aerospace industries. The lithium class of batteries has gained popularity for various reasons including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

An example of a positive electrode includes sulfur based active material particles, a carbon coating encapsulating the sulfur based active material particles, and a structure coating formed on a surface of the carbon coating. The structure coating is selected from the group consisting of a metal oxide composite structure, a mixed carbon and metal oxide composite structure, and a polymeric coating.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic, cross-sectional view of an example of a positive electrode according to an example of the present disclosure, an example of a negative electrode according to an example of the present disclosure, and a separator positioned therebetween;

FIG. 2 is a schematic, perspective view of an example of a lithium-sulfur battery showing a charging and discharging state, the battery including an example of the positive electrode disclosed herein;

FIG. 3 is a schematic view of an example of a system for coating the particles or electrode(s);

FIG. 4 is a schematic view of an industrial Atomic Layer Deposition (ALD) unit used for coating the particles or electrode(s);

FIG. 5 is a graph illustrating the discharge and charge capacity (mAh/g) and the Coulombic efficiency for a coin cell including an example of the coated electrode disclosed herein; and

FIG. 6 is a graph illustrating the electrochemical potential versus Li⁺/Li⁻ (Y axis) versus the specific capacity (mAh/g) over several cycles for the coin cell including the example of the coated electrode disclosed herein.

### DETAILED DESCRIPTION

Lithium-sulfur batteries and other lithium ion batteries generally operate by reversibly passing lithium ions between a negative electrode (sometimes called an anode) and a positive electrode (sometimes called a cathode). The negative and positive electrodes are situated on opposite sides of a porous polymer separator soaked with an electrolyte solution that is suitable for conducting the lithium ions. Each of the electrodes is also associated with respective current collectors, which are connected by an interruptible external circuit that allows an electric current to pass between the negative and positive electrodes.

It has been found that the lithium-sulfur battery life cycle may be limited by the migration, diffusion, or shuttling of polysulfides (e.g., lithium polysulfide intermediates, Li₂Sₓ where 2<x<8) from the sulfur cathode during the battery discharge process, through the porous polymer separator, to the anode. The polysulfides generated at the cathode are soluble in the electrolyte, and can migrate to the anode (e.g., a lithium electrode) where they react with the anode in a parasitic fashion to generate lower-order polysulfides. These polysulfides diffuse back to the cathode and regenerate the higher forms of polysulfide. As a result, a shuttle effect takes place. This effect leads to decreased sulfur utilization, self-discharge, poor cycleability, and reduced Coulombic efficiency of the battery. It is believed that even a small amount of polysulfide, such as Li₂S, at the anode can permanently bond to the negative electrode and lead to parasitic loss of active lithium at the anode, which prevents reversible electrode operation and reduces the useful life of the lithium-sulfur battery.

Similarly, it has been found that the lithium ion battery containing a manganese-based cathode may suffer from manganese dissolution. For instance, a graphite anode may be poisoned by Mn⁺² cations that dissolve from spinel LiMn₂O₄ of the cathode. For instance, the Mn⁺² cations may migrate through the battery electrolyte and porous polymer separator, and deposit onto the graphite electrode. When deposited onto the graphite, the Mn⁺² cations become Mn atoms. It is believed that a small amount (e.g., 1 ppm) of Mn atoms can poison the graphite electrode, and prevent reversible electrode operation and thus reduce the useful life of the battery.

In some of the examples disclosed herein, the diffusive polysulfide of the lithium-sulfur battery or the diffusive Mn⁺² cations of the lithium ion battery may be reduced or prevented by incorporating a structure coating at or near the surface of the positive electrode, or in some examples at the surface of the negative electrode. In any of the examples disclosed herein, the structure coating may be formed of a metal oxide (e.g., an aluminum oxide, an antimony oxide, a calcium oxide, a magnesium oxide, a tin oxide, a titanium oxide, a silicon oxide, a vanadium oxide, a zirconium oxide, and mixtures thereof), or a mixture of carbon and metal oxide, or a polymer. The structure coating may be a homogeneous composite or a heterogeneous composite. In particular, a heterogeneous composite structure coating or a polymeric structure coating can act as an artificial solid-electrolyte interphase (SEI) layer that prevents Li dissolution. The structure coating may be a single layer, a bilayer, or a multi-layered structure with three or more layers. The structure coating is lithium conducting and also includes pores sized to i) allow lithium ions to pass through and ii) block polysulfide ions or manganese cations from passing through. As such, the structure coating disclosed herein acts as a barrier that may improve the capacity and useful life of the battery.

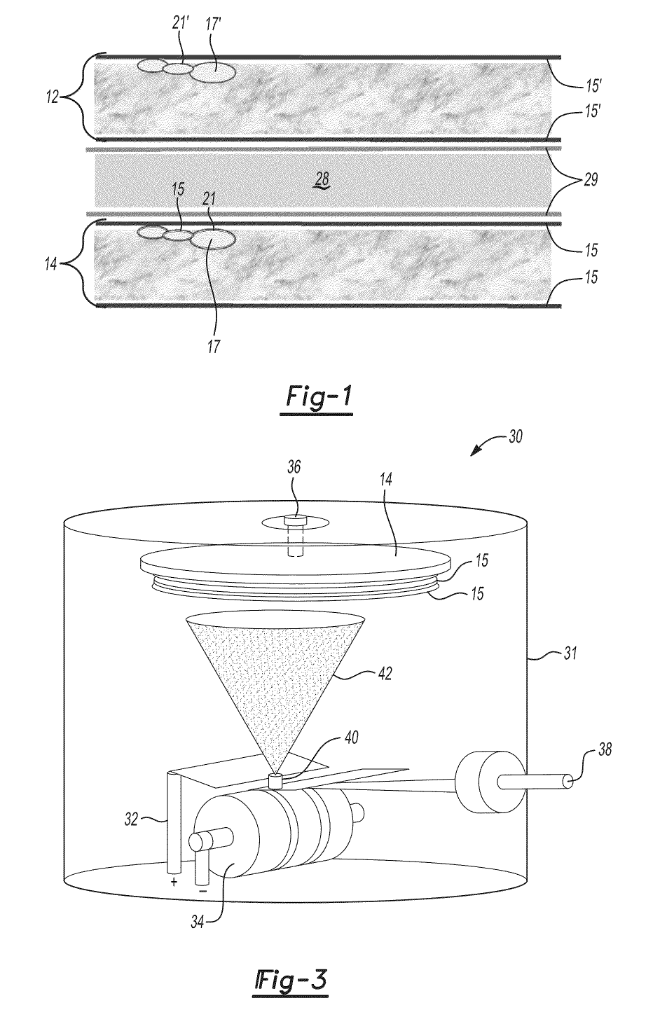

An example of the positive electrode 14 is shown in FIG. 1. The positive electrode 14 is shown adjacent to a porous polymer separator 28 (which is filled with an electrolyte 29), which is adjacent to a negative electrode 12.

When used in a lithium-sulfur battery, the positive electrode 14 is a sulfur based positive electrode made up of sulfur particles 17 as the active material. The sulfur particles 17 are coated with a carbon coating 21 (which may have a similar structure to the structure coatings disclosed herein) and are also coated with an example of the structure coating 15 disclosed herein. In an example, the cathode 14 is made up of the coated particles 17 and a binder (i.e., the surface of the cathode 14 is not coated with the structure coating 15 disclosed herein). As shown in FIG. 1, in another example, the cathode 14 is made up of the coated particles 17 and a binder, and a surface of the cathode 14 is also coated with the structure coating 15 disclosed herein. In these examples, the structure coating(s) 15 blocks the polysulfides from contacting the electrolyte 29.

When used in a lithium ion battery, the positive electrode 14 is made up of a lithium and/or manganese based active material and a binder. The lithium and/or manganese particles are coated with a carbon coating (similar to layer 21 which may have a similar structure to the structure coatings disclosed herein) and are also coated with an example of the structure coating 15 disclosed herein. In an example, the cathode 14 is made up of the coated particles and a binder (i.e., the surface of the cathode 14 is not coated with the structure coating 15 disclosed herein). In still another example, the cathode 14 is made up of the coated particles and a binder, and a surface of the cathode 14 is also coated with the structure coating 15 disclosed herein. In these examples, the structure coatings 15 block the manganese cations from contacting the electrolyte 29.

In another example, the cathode 14 is made up of the coated sulfur particles 17 and a binder, and a surface of the anode 12 is coated with the structure coating 15′ disclosed herein. In yet another example (as shown in FIG. 1), the cathode 14 is made up of these coated sulfur particles 17 and a binder, and the respective surfaces of each of the cathode 14 and the anode 12 are also coated with the structure coating 15, 15′ disclosed herein. In still a further example, the cathode 14 is made up of the lithium and/or manganese based active material and the binder, and the surfaces of the cathode 14 and/or the anode 12 are coated with the structure coating 15, 15′ disclosed herein. When the anode 12 is coated with the structure coating 15′, the coating 15′ also acts as a barrier for any polysulfides (in a lithium-sulfur battery) or manganese cations (in a lithium ion battery) that may be present in the electrolyte 29, and keeps these species from reaching the anode surfaces.

The coated electrode(s) 12, 14 disclosed herein may also benefit the volume expansion and contraction during lithiation and delithiation processes.

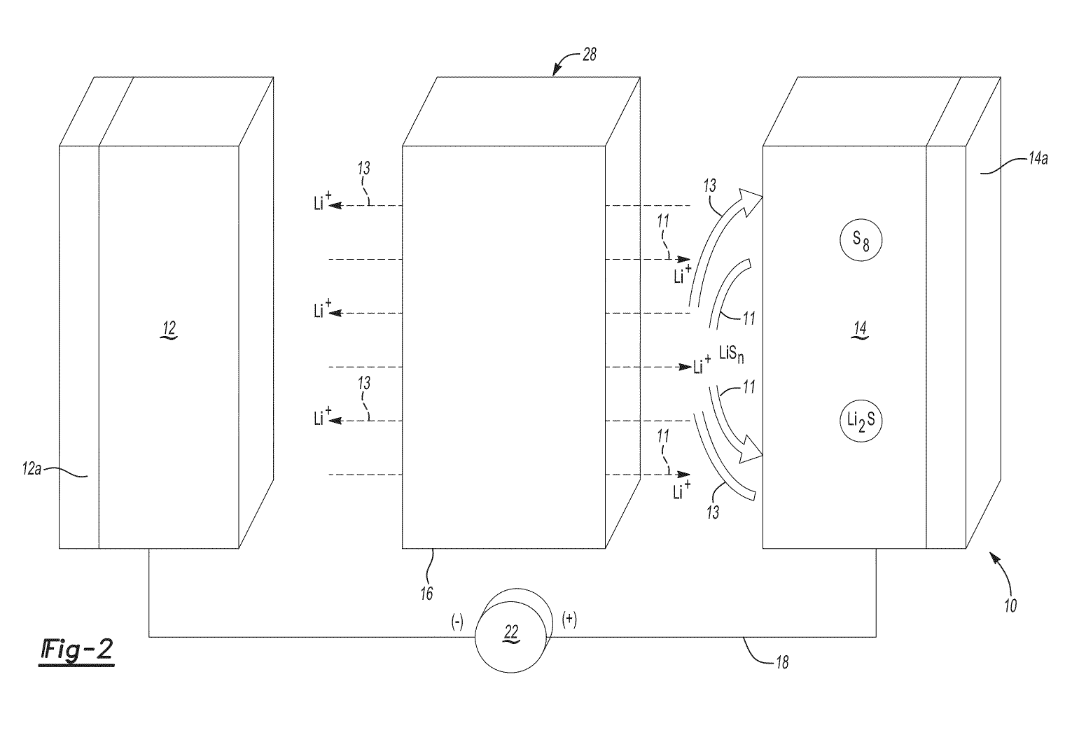

Details of the structure coating 15, 15′ and the various components 12, 14, 28, 29 will be described further in reference to FIG. 2.

An example of a secondary lithium-sulfur battery 10 is schematically shown in FIG. 2. The battery 10 generally includes the anode 12, the cathode 14, and the porous polymer separator 28. The porous polymer separator 28 includes a porous polymer membrane 16. Each of the anode 12, the cathode 14, and the porous polymer separator 16 are soaked in an electrolyte solution 29 (see FIG. 1) that is capable of conducting lithium ions. The lithium-sulfur battery 10 also includes an interruptible external circuit 18 that connects the anode 12 and the cathode 14.

The porous polymer separator 28, which operates as both an electrical insulator and a mechanical support, is sandwiched between the anode 12 and the cathode 14 to prevent physical contact between the two electrodes 12, 14 and the occurrence of a short circuit. The porous polymer separator 28, in addition to providing a physical barrier between the two electrodes 12, 14, ensures passage of lithium ions (identified by the Li′) and some related anions through the electrolyte solution 29 filling its pores.

A negative-side current collector 12a and a positive-side current collector 14a may be positioned in contact with the anode 12 and the cathode 14, respectively, to collect and move free electrons to and from the external circuit 18.

The lithium-sulfur battery 10 may support a load device 22 that can be operatively connected to the external circuit 18. The load device 22 may be powered fully or partially by the electric current passing through the external circuit 18 when the lithium-sulfur battery 10 is discharging. While the load device 22 may be any number of known electrically-powered devices, a few specific examples of a power-consuming load device include an electric motor for a hybrid vehicle or an all-electrical vehicle, a laptop computer, a cellular phone, and a cordless power tool. The load device 22 may also, however, be a power-generating apparatus that charges the lithium-sulfur battery 10 for purposes of storing energy. For instance, the tendency of windmills and solar panels to variably and/or intermittently generate electricity often results in a need to store surplus energy for later use.

The lithium-sulfur battery 10 can include a wide range of other components that, while not depicted here, are nonetheless known to skilled artisans. For instance, the lithium-sulfur battery 10 may include a casing, gaskets, terminals, tabs, and any other desirable components or materials that may be situated between or around the anode 12 and the cathode 14 for performance-related or other practical purposes. Moreover, the size and shape of the lithium-sulfur battery 10, as well as the design and chemical make-up of its main components, may vary depending on the particular application for which it is designed. Battery-powered automobiles and hand-held consumer electronic devices, for example, are two instances where the lithium-sulfur battery 10 would most likely be designed to different size, capacity, and power-output specifications. The lithium-sulfur battery 10 may also be connected in series and/or in parallel with other similar lithium-sulfur batteries 10 to produce a greater voltage output and current (if arranged in parallel) or voltage (if arranged in series) if the load device 22 so requires.

The lithium-sulfur battery 10 can generate a useful electric current during battery discharge (shown by reference numeral 11 in FIG. 2). During discharge, the chemical processes in the battery 10 include lithium (Li⁺) dissolution from the surface of the anode 12 and incorporation of the lithium cations into alkali metal polysulfide salts (i.e., Li₂S) within the cathode 14. As such, polysulfides are formed (sulfur is reduced) on the surface of the cathode 14 in sequence while the battery 10 is discharging. The chemical potential difference between the cathode 14 and the anode 12 (ranging from approximately 1.5 to 3.0 volts, depending on the exact chemical make-up of the electrodes 12, 14) drives electrons produced by the dissolution of lithium at the anode 12 through the external circuit 18 towards the cathode 14. The resulting electric current passing through the external circuit 18 can be harnessed and directed through the load device 22 until the lithium in the anode is depleted and the capacity of the lithium-sulfur battery 10 is diminished.

The lithium-sulfur battery 10 can be charged or re-powered at any time by applying an external power source to the lithium-sulfur battery 10 to reverse the electrochemical reactions that occur during battery discharge. During charging (shown at reference numeral 13 in FIG. 2), lithium plating to the anode 12 takes place and sulfur formation at the cathode 14 takes place. The connection of an external power source to the lithium-sulfur battery 10 compels the otherwise non-spontaneous oxidation of lithium at the cathode 14 to produce electrons and lithium ions. The electrons, which flow back towards the anode 12 through the external circuit 18, and the lithium ions (Li⁺), which are carried by the electrolyte 29 across the porous polymer separator 28 back towards the anode 12, reunite at the anode 12 and replenish it with lithium for consumption during the next battery discharge cycle. The external power source that may be used to charge the lithium-sulfur battery 10 may vary depending on the size, construction, and particular end-use of the lithium-sulfur battery 10. Some suitable external power sources include a battery charger plugged into an AC wall outlet and a motor vehicle alternator.

The anode 12 may include any lithium host material (i.e., active material) that can sufficiently undergo lithium plating and stripping while copper or another current collector is functioning as the negative terminal of the lithium-sulfur battery 10. Examples of the active material 17′ for the anode 12 include graphite, a low surface area amorphous carbon crystalline silicon, amorphous silicon, silicon oxide, silicon alloys, germanium, tin, antimony, metal oxides, etc. Examples of suitable metals that may be alloyed with silicon include tin, aluminum, iron, or combinations thereof. Examples of suitable metal oxides include iron oxide (Fe₂O₃), nickel oxide (NiO), copper oxide (CuO), etc. Graphite is widely utilized to form the anode 12 because it exhibits reversible lithium intercalation and deintercalation characteristics, is relatively non-reactive, and can store lithium in quantities that produce a relatively high energy density. Commercial forms of graphite that may be used to fabricate the anode 12 are available from, for example, Timcal Graphite & Carbon (Bodio, Switzerland), Lonza Group (Basel, Switzerland), or Superior Graphite (Chicago, Ill.). Other materials can also be used to form the anode 12 including, for example, lithium titanate. The active material 17′ of the anode 12 may also be formed of silicon particles that are coated with a carbon coating 21′. The carbon coating 21′ may have a structure similar to the coating 15, 15′. The active material 17′ may be in the form of a powder, particles, nanowires, nanotubes, nanofibers, core-shell structures, etc.

The anode 12 may also include a polymer binder material to structurally hold the lithium host material together. For example, the anode 12 may be formed of the active material intermingled with the binder made from polyvinylidene fluoride (PVdF), an ethylene propylene diene monomer (EPDM) rubber, sodium alginate, or carboxymethyl cellulose (CMC). These materials may be mixed with a conductive filler. An example of a conductive filler is a high surface area carbon, such as acetylene black, which ensures electron conduction between the current collector 12a and the active material particles 17′ of the anode 12.

The negative-side current collector 12a may be formed from copper or any other appropriate electrically conductive material known to skilled artisans.

The cathode 14 of the lithium-sulfur battery 10 may be formed from any sulfur-based active material 17 that can sufficiently undergo lithiation and delithiation while functioning as the positive terminal of the lithium-sulfur battery 10. Examples of sulfur-based active materials 17 include S₈, Li₂S₈, Li₂S₆, Li₂S₄, Li₂S₂, and Li₂S. The sulfur-based active materials may be in the form of particles 17, which are encapsulated with the carbon coating 21. The cathode 14 may also include a polymer binder material to structurally hold the coated sulfur-based active material particles 17 together. The polymeric binder may be made of at least one of polyvinylidene fluoride (PVdF), polyethylene oxide (PEO), an ethylene propylene diene monomer (EPDM) rubber, or carboxymethyl cellulose (CMC)).

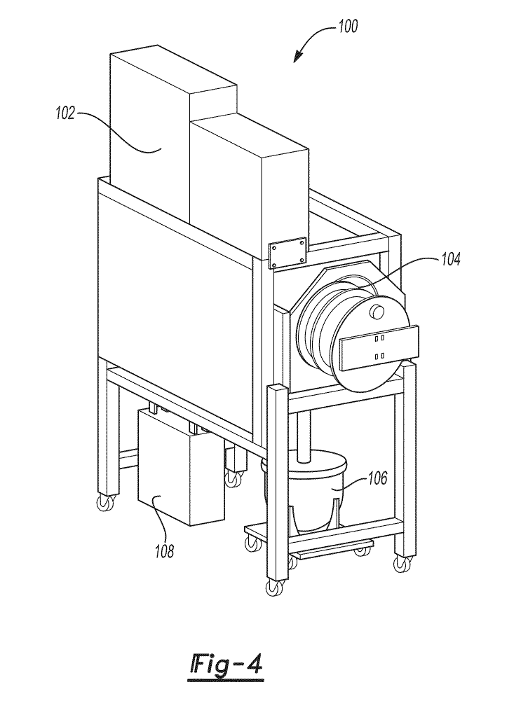

As mentioned above, the particles 17 also include the structure coating 15 formed on the carbon coating 21. This structure coating 15′ may also be formed on the outermost surface(s) of the cathode 14 and/or the anode 12. Wherever the structure coating 15, 15′ is placed, the coating 15, 15′ aids in preventing the polysulfides from reaching the anode 12 (either by blocking them from leaving the cathode 14 and/or from reaching the anode 12). The structure coating 15, 15′ is a metal oxide composite structure coating, or a mixed carbon and metal oxide composite structure coating, or a polymeric structure coating. The metal oxide may be an aluminum oxide, an antimony oxide, a calcium oxide, a magnesium oxide, a tin oxide, a titanium oxide (e.g., TiO₂ or Ti₄O₇), a silicon oxide, a tungsten oxide (e.g., WO₃) a vanadium oxide, a zirconium oxide, and mixtures thereof. Examples of the polymer include perfluorinated polymers, polyethylene oxides (PEO), etc. The structure coating 15, 15′ itself is lithium conducting and includes pores which are small enough to block polysulfide ions from moving therethrough, and are large enough to allow lithium cations to move therethrough. The structure coating 15, 15′ (whether formed on particles 17 or electrode surface(s)) has a thickness of 2 μm or less (e.g., down to about 1 nm). In other examples, the thickness is 100 nm or less, or 50 nm or less. Examples of how the structure coating 15, 15′ is formed will be discussed further in reference to FIGS. 3 and 4.

The positive-side current collector 14a may be formed from aluminum or any other appropriate electrically conductive material known to skilled artisans.

Any appropriate electrolyte solution that can conduct lithium ions between the anode 12 and the cathode 14 may be used in the lithium-sulfur battery 10. In one example, the non-aqueous electrolyte solution may be an ether based electrolyte that is stabilized with lithium nitrite. Other non-aqueous liquid electrolyte solutions may include a lithium salt dissolved in an organic solvent or a mixture of organic solvents. Examples of lithium salts that may be dissolved in the ether to form the non-aqueous liquid electrolyte solution include LiClO₄, LiAlCl₄, LiI, LiBr, LiSCN, LiBF₄, LiB(C₆H₅)₄, LiCF₃SO₃, LiN(FSO₂)₂, LiN(CF₃SO₂)₂, LiAsF₆, LiPF₆, LITFSI, LiB(C₂O₄)₂ (LiBOB), LiBF₂(C₂O₄) (LiODFB), LiPF₄(C₂O₄) (LiFOP), LiNO₃, and mixtures thereof. The ether based solvents may be composed of cyclic ethers, such as 1,3-dioxolane, tetrahydrofuran, 2-methyltetrahydrofuran, and chain structure ethers, such as 1,2-dimethoxyethane, 1-2-diethoxyethane, ethoxymethoxyethane, tetraethylene glycol dimethyl ether (TEGDME), polyethylene glycol dimethyl ether (PEGDME), and mixtures thereof.

The porous polymer membrane 16 of the porous polymer separator 28 may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP. Commercially available porous polymer membranes include single layer polypropylene membranes, such as CELGARD 2400 and CELGARD 2500 from Celgard, LLC (Charlotte, N.C.). It is to be understood that the porous polymer membrane 16 is uncoated or untreated. For example, the porous polymer membrane does not include any surfactant treatment thereon. It is believed that the uncoated/untreated membrane adheres better to the structure coating 15.

In another example, the membrane 16 of the porous polymer separator 28 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the membrane 16 of the separator 28 is poly(p-hydroxybenzoic acid). In yet another example, the membrane 16 of the porous polymer separator 18 may be chosen from a combination of the polyolefin (such as PE and/or PP) and one or more of the polymers for the membrane 16 listed above.

The porous polymer membrane 16 may be a single layer or may be a multi-layer (e.g., bilayer, trilayer, etc.) laminate fabricated from either a dry or wet process. In some instances, the membrane 16 may include fibrous layer(s) to impart appropriate structural and porosity characteristics.

FIG. 2 illustrates a lithium-sulfur battery 10. However, as noted above, a lithium ion battery (not shown) including a lithium and/or manganese-based positive electrode may also benefit from the structure coating 15 and/or 15′ disclosed herein being deposited on lithium and/or manganese active material particles of the positive electrode/cathode 14, on a surface of the positive electrode/cathode 14, and/or on a surface of the negative electrode/anode 12. It is to be understood that the materials and thickness of the structure coating 15, 15′ previously described may be used in a lithium ion battery.

In an example of a lithium ion battery, the positive electrode 14 may include the lithium and/or manganese active material intermingled with a polymeric binder (e.g., polyvinylidene fluoride (PVdF), an ethylene propylene diene monomer (EPDM) rubber, and/or carboxymethyl cellulose (CMC)) and mixed with a conductive filler (e.g., a high surface area carbon, such as acetylene black). The active material in this positive electrode 14 may be made of at least one of spinel lithium manganese oxide (LiMn₂O₄), a nickel-manganese oxide spinel [Li(Ni_{0.5}Mn_{1.5})O₂], a layered nickel-manganese-cobalt oxide [Li(NiₓMn_{y}Co_{z})O₄], or a lithium iron polyanion oxide, such as lithium iron phosphate (LiFePO₄) or lithium iron fluorophosphate (Li₂FePO₄F), Li₂MSiO₄ (M=Co, Fe, Mn), a lithium rich layer-structure cathode, such as xLi₂MnO₃-(1−x)LiMO₂ (M is composed of any ratio of Ni, Mn and Co), HE-NMC (high efficiency Nickel-Manganese-Cobalt) cathodes, lithium cobalt oxide (LiCoO₂), lithium nickel-cobalt oxide (LiNiₓCo₁₋ₓO₂), aluminum stabilized lithium manganese oxide spinel (LiₓMn₂₋ₓAl_{y}O₄), and lithium vanadium oxide (LiV₂O₅).

Any of the variations of the electrodes 12, 14 disclosed herein may include up to 90% by weight (i.e., 90 wt %) of the respective active material, up to 20 wt % of the conductive filler, and up to 20 wt % of the polymer binder material.

In any of the examples disclosed herein, the carbon coating 21, 21′ on the particles 17 (or on anode particles 17′) and the various examples of the structure coating 15, 15′ may be formed using a laser arc plasma deposition process, a cathodic arc deposition process, a pulsed laser deposition process, chemical vapor deposition (CVD), atomic layer deposition (ALD), or plasma-assisted chemical vapor deposition (PE-CVD). It is believed that better adhesion between particles 17, 17′ or the electrode 12, 14 and the structure coating 15, 15′ may also be obtained using these processes.

FIG. 3 schematically illustrates an example of the system 30 used in laser arc plasma deposition. In an example, a substrate holder 36 holds the electrode 12 or 14 in place within a vacuum chamber 31 (having a pressure of about 10⁻⁴ Pa). In another example, a quartz jar may be used to hold the sulfur particles 17 (or silicon particles 17′ for an anode or lithium and/or manganese particles for a lithium ion battery cathode). In general, an electric arc or thermal arc is used to vaporize material 42 from a cathode target 34 (which is operatively connected to an anode 32). The vaporized material 42 (e.g., carbon and/or metal oxide) then condenses on the sulfur particles 17 or electrode 12 or 14. In the example shown in FIG. 3, a pulsing and oscillating laser beam 38 strikes the surface of the cathode target 34 with a high current, forming a cathode spot. The cathode target 34 may be a carbon target (e.g., a graphite target) or a metal oxide target (e.g., aluminum oxide, antimony oxide, calcium oxide, magnesium oxide, tin oxide, titanium oxide, silicon oxide, vanadium oxide, and zirconium oxide). At the cathode spot, plasma is ignited (reference numeral 40), which generates a jet of vaporized material 42 of carbon and/or metal oxide which forms the structure coating 15, 15′ on the sulfur particles 17 or electrode 12 or 14. The cathode spot is active for a short period of time, and then it self-extinguishes and re-ignites in a new area close to the previous spot. This causes the apparent motion of the arc.

In an example system 30, the chamber 31 is a Laser-Arc Module (LAM) vacuum chamber, and the laser beam 38 is produced using a pulsed solid-state Nd:YAG laser (wavelength 1.06 μm, pulse length 150 ns, 10 kHz repetition rate, average pulse power density 15 mJ cm⁻²). The system 30 may also include a pulsed power supply (peak current 2 kA, pulse length 100 μs, repetition rate 1.8 kHz, average current 260 A) and a software/hardware controller. In an example, the chamber 31 houses a cylindrical (e.g., 160 mm diameter, up to 500 mm length) graphite (which functions as the cathode 34) and metal oxide target and a rod-shaped anode 32 for the arc discharge. The cathode 34 and anode 32 may be externally connected to a charged capacitor bank in the pulse power supply.

In an example, the laser pulses aim through a window into the LAM chamber 31 and focus onto the surface of the graphite cylinder target 34. The 150 ns laser pulse generates a rapidly expanding carbon plasma plume, which in turn ignites a 150 μs vacuum arc discharge pulse between graphite target (cathode 34) and an anode 32. The vacuum arc discharge is the main energy source to evaporate the graphite. The pulse forming components of the power supply are designed to adjust the maximal arc current, timing and pulse shape. It is to be understood that a combination of a rotating target 34 with a linear scan of the laser pulse (arc location) along the length of the target 34 ensures very uniform target erosion and film deposition. A single laser can be used to ignite several arc sources for boosting deposition rates for wear coating deposition.

FIG. 4 illustrates an example of a system 100 for performing atomic layer deposition of the carbon coating(s) 21, 21′ and/or the structure coating 15, 15′. In an example, the system 100 is an industrial Atomic Layer Deposition (ALD) unit, e.g., a P400A unit, commercially available from Beneq, Inc. (Duluth, Ga.). The ALD system 100 generally includes a control unit 102, a sample loading chamber 104, a cold trap 106, and a pump 108. This ALD system 100 allows the application of self-limiting or sequentially self-terminating films via chemical vapor deposition through a layer by layer process. Some advantages of this self-limiting film include uniform surfaces, high conformity to surface features, high control and accuracy of atomic level thickness, and high reproducibility. This type of system may be desirable, for example, when coating the particles 17 or silicon particles 17′ for an anode 12.

It is to be understood that the systems shown in FIGS. 3 and 4 are examples, and that any system suitable for performing any of the deposition techniques disclosed herein may be used.

The polymer or carbon and/or metal oxide thin films (i.e., structure coatings) may be reproducibly deposited over a wide thickness range from a few nanometers to a few micrometers. As such, these deposition techniques also enable control over the thickness of the carbon coating on the particles 17, 17′ and the various examples of the structure coating 15, 15′. In an example, the thickness is less than 2 μm. Film thickness control may accomplished by adjusting the number of ignited arc discharges (i.e., discharge pulses). In an example, the thickness may decreased by lowering the plasma laser arc discharge pulses. Film thickness control may also be accomplished by adjusting the processing time. Generally, longer processing times results in thicker films.

To further illustrate the present disclosure, an example is given herein. It is to be understood that this example is provided for illustrative purposes and is not to be construed as limiting the scope of the present disclosure.

### Example

Sulfur layer-by-layer electrodes (including a core of sulfur, a carbon layer, and an Al₂O₃ composite structure coating) were fabricated in coin cells (Pred Materials International, Inc. CR2325 coin cell kit: case SUS430, cap SUS 304, gasket PP9103-54; National Research Council Canada-ICPET: a disc spacer with a 0.71 mm thick×20 mm diameter Gauge 430BA stainless steel passivated spacer and a spring with 301 stainless steel Belleville stack loading spring). The coin cell fabrication was performed in an Ar atmosphere glovebox. Coin half-cells were assembled with lithium metal foils (a 0.38 mm thick×18 mm diameter) as the counter electrodes, whereas coin full-cells were constructed with a C/Si deposition as an anode, and sulfur layer-by-layer electrode as a cathode. A 25 μm thick×21 mm diameter trilayer separator (Celgard, LLC) was made of PP/PE/PP, and the electrolyte was an ether based electrolyte with 0.9M LiTFSI-DME-2% LiNO₂-10% FEC.

All of the electrochemical testing was performed using a MACCOR® battery cycler system. The coin cells were held at least 10 hours before starting cycles. The galvanostatic testing was performed at a current of about 0.1 mA under voltage limits of 2.7V to 1.5V.

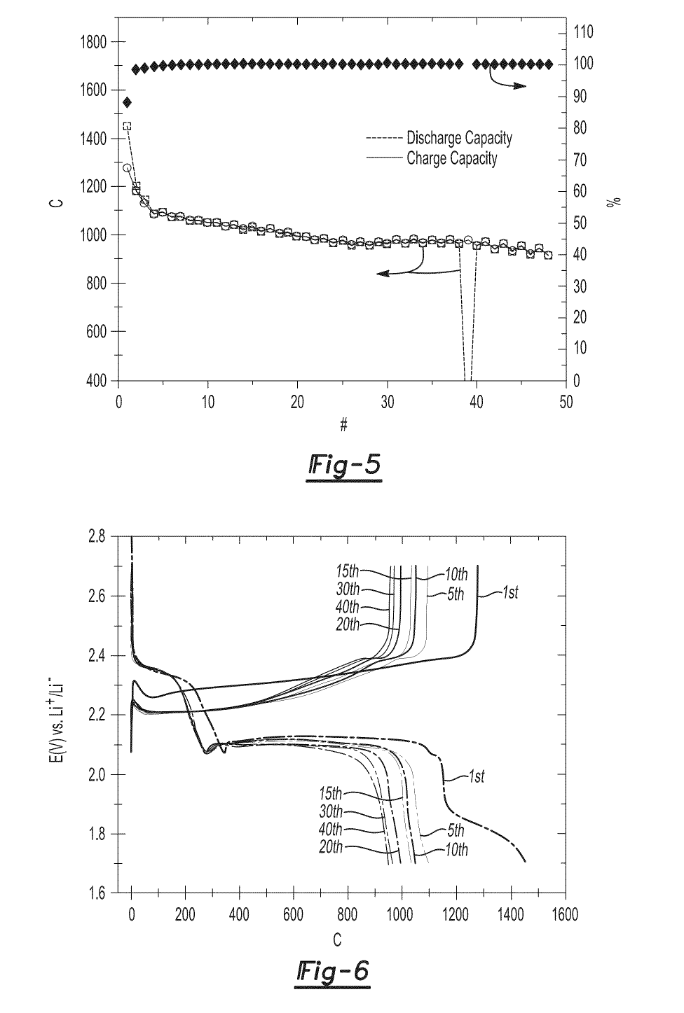

FIG. 5 depicts the discharge and charge capacity (mAh/g) (Y axis labeled “C” on the left side) versus the cycle number (X axis labeled “#”) for one of the coin cells. The Coulombic efficiency (%) (Y axis labeled “%” on the right side) is also shown. These results demonstrate the stability and efficiency of the system including the sulfur layer-by-layer electrode.

FIG. 6 depicts the electrochemical potential E(V) vs. Li⁺/Li⁻ (Y axis) versus the specific capacity (mAh/g) of the coin cell for several cycles (1, 5, 10, 15, 20, 30 and 40). These results also exhibit system stability.

It is to be understood that the ranges provided herein include the stated range and any value or sub-range within the stated range. For example, a range of 50 nm or less should be interpreted to include not only the explicitly recited limits of 50 nm or less, but also to include individual values, such as 10.5 nm, 25 nm, 38 nm, etc., and sub-ranges, such as from about 1 nm to about 49 nm; from about 5 nm to about 40 nm, etc. Furthermore, when “about” is utilized to describe a value, this is meant to encompass minor variations (up to +/−5%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A positive electrode, comprising:
sulfur based active material particles;
a carbon coating encapsulating the sulfur based active material particles; and
a structure coating formed on a surface of the carbon coating, the structure coating being selected from the group consisting of a metal oxide composite structure coating, a mixed carbon and metal oxide composite structure coating, and a polymeric structure coating.

2. The positive electrode as defined in claim 1, further comprising a binder.

3. The positive electrode as defined in claim 1 wherein the metal oxide composite structure coating or a metal oxide of the mixed carbon and metal oxide composite structure coating is selected from the group consisting of an aluminum oxide, an antimony oxide, a calcium oxide, a magnesium oxide, a tin oxide, a titanium oxide, a tungsten oxide, a silicon oxide, a vanadium oxide, a zirconium oxide, and mixtures thereof.

4. The positive electrode as defined in claim 1 wherein the structure coating is lithium conducting and is to block transport of polysulfide ions.

5. The positive electrode as defined in claim 1 wherein the structure coating includes at least two layers.

6. The positive electrode as defined in claim 1 wherein the structure coating is formed from a laser arc plasma deposition process, a cathodic arc deposition process, a pulsed laser deposition process, a chemical vapor deposition process, an atomic layer deposition process, or a plasma enhanced chemical vapor deposition process.

7. The positive electrode as defined in claim 1 wherein the structure coating is also formed on a surface of the positive electrode.

8. A lithium sulfur battery, comprising:
a sulfur based positive electrode;
a structure coating formed on a surface of the sulfur based positive electrode, the composite structure coating being selected from the group consisting of a metal oxide composite structure coating, a mixed carbon and metal oxide composite structure coating, and a polymeric structure coating;
a negative electrode; and
a porous polymer separator disposed between the sulfur based positive electrode and the negative electrode.

9. The lithium sulfur battery as defined in claim 8 wherein the sulfur based positive electrode includes:
sulfur based active material particles;
a carbon coating encapsulating the sulfur based active material particles; and
the structure coating formed on a surface of the carbon coating.

10. The lithium sulfur battery as defined in claim 8, further comprising an other structure coating formed on a surface of the negative electrode.

11. The lithium sulfur battery as defined in claim 8 wherein the negative electrode includes silicon particles coated with a carbon composite structure coating.
